(19) United States
(12) Patent Application Publication
(10) Pub. No.: US 2025/0161977 A1
(43) Pub. Date: May 22, 2025

(54) FILM AND METHOD FOR PRODUCING SAME

(71) Applicant: Murata Manufacturing Co., Ltd., Nagaokakyo-shi (JP)

(72) Inventors: Akari SEKO, Nagaokakyo-shi (JP); Shun SAKAIDA, Nagaokakyo-shi (JP)

(21) Appl. No.: 18/990,315

(22) Filed: Dec. 20, 2024

Related U.S. Application Data
(63) Continuation of application No. PCT/JP2023/015582, filed on Apr. 19, 2023.

(30) Foreign Application Priority Data
Jun. 24, 2022 (JP) 2022-102062
Feb. 20, 2023 (JP) 2023-024506

(51) Int. Cl. B05D 1/02; C01B 32/921

(52) U.S. Cl. CPC B05D 1/02; C01B 32/921; C01P 2002/08; C01P 2002/20; C01P 2004/24

(57) ABSTRACT

A film that includes two-dimensional particles having one or plural layers, and N-methylformamide. The one or plural layers include a layer body represented by: MₘXₙ wherein “M” is at least one Group 3, 4, 5, 6, or 7 metal, “X” is a carbon atom, a nitrogen atom, or a combination thereof, “n” is 1 to 4, and “m”>“n” and “m”≤5; and at least one modifier or terminal “T” is present on a surface of the layer body, wherein each “T” is a hydroxyl group, a fluorine atom, a chlorine atom, an oxygen atom, or a hydrogen atom. The N-methylformamide is disposed between two adjacent layers of the one or plural layers, and a content of the N-methylformamide in the film is 0.104 mol or more with respect to 1 mol of MₘXₙ.

### CROSS-REFERENCE TO RELATED APPLICATIONS

The present application is a continuation of International Patent Application No. PCT/JP2023/015582, filed Apr. 19, 2023, and claims the benefit of priority to Japanese Patent Application Nos. 2023-024506, filed Feb. 20, 2023, and 2022-102062, filed Jun. 24, 2022, the entire contents of each of which are incorporated herein by reference.

### TECHNICAL FIELD

The present disclosure relates to a film and a method for producing the same, and more particularly to a film comprising two-dimensional particles and a method for producing the same.

### BACKGROUND ART

In recent years, MXene has been attracting attention as a new material having conductivity. MXene is a type of so-called two-dimensional material, and as will be described later, is a layered material in the form of one or plural layers. In general, MXene is in the form of particles (which may comprise powders, flakes, nanosheets, and the like) of such a layered material.

Currently, various studies are being conducted toward the application of MXene to various electrical devices. For example, studies have been made to improve the conductivity of a material including MXene and to broaden the applicability of the material including MXene.

CN-A-112795209 (“CN '209”) describes that the conductivity can be improved by removing an intercalator used for producing MXene by acid treatment.

Chuanfang (John) Zhang, et al., “Additive-free MXene inks and direct printing of micro-supercapacitors”Nature Comm. 10, 1795 (2019), describes that MXene is dispersed in a solvent such as N-methylpyrrolidone, dimethyl sulfoxide, dimethylformamide, or ethanol to form an ink, and the ink is directly printed on a microsupercapacitor.

### SUMMARY OF THE DISCLOSURE

The conductivity of MXene described in Zhanga and CN '209 may decrease with time.

One object of the present disclosure is to provide a film in which a decrease in conductivity with time is suppressed, and preferably to provide a film in which a decrease in conductivity with time is suppressed even under high temperature and high humidity. Another object of the present disclosure is to provide a method for producing the film.

In some aspects, a film of the present disclosure is a film comprising two-dimensional particles, wherein the two-dimensional particles are two-dimensional particles having one or plural layers, and comprise N-methylformamide, wherein the one or plural layers comprise a layer body represented by a formula below:

MₘXₙ
wherein “M” is at least one Group 3, 4, 5, 6, or 7 metal,
   “X” is a carbon atom, a nitrogen atom, or a combination thereof,
   “n” is 1 to 4, and
   “m”>“n” and “m”≤5; and
at least one modifier or terminal “T” is present on a surface of the layer body, wherein each “T” is a hydroxyl group, a fluorine atom, a chlorine atom, an oxygen atom, or a hydrogen atom,
the N-methylformamide is disposed between two adjacent layers of the one or plural layers, and
a content of the N-methylformamide in the film is 0.104 mol or more with respect to 1 mol of MₘXₙ.

A method for producing a film of the present disclosure, the method comprising:
(a) preparing a precursor represented by a formula below:

MₘAXₙ
wherein “M is at least one Group 3, 4, 5, 6, or 7 metal, and comprises at least Ti,
   “X” is a carbon atom, a nitrogen atom, or a combination thereof,
   “A” is at least one Group 12, 13, 14, 15, or 16 element,
   “n” is 1 to 4, and
   “m”>“n” and “m”≤5;
(b) removing at least a portion of the “A” element atoms from the precursor using an etching solution to obtain an etched product;
(c) cleaning the etched product to obtain an etched and cleaned product;
(d) mixing the etched and cleaned product with an intercalator to obtain an intercalated product;
(e) stirring the intercalated product to obtain a delaminated product in which the intercalated product is delaminated;
(f) mixing the delaminated product with N-methylformamide to obtain a mixed solution;
(h) forming a precursor film using the mixed solution; and
(i) drying the precursor film under normal pressure to form the film.

The present disclosure provides films in which a decrease in conductivity with time is suppressed, e.g., to provide a film in which a decrease in conductivity with time is suppressed even under high temperature and high humidity. In other aspects, the present disclosure also provides methods for producing such films.

### BRIEF DESCRIPTION OF THE DRAWINGS

FIGS. 1(a) and 1(b) are schematic cross-sectional views showing MXene particles as a layered material according to one embodiment of the present disclosure. FIG. 1(a) shows single-layer MXene particles, and FIG. 1(b) shows multilayer (in this case, two-layer) MXene particles.

FIG. 2 is a schematic cross-sectional view showing a film according to one embodiment of the present disclosure.

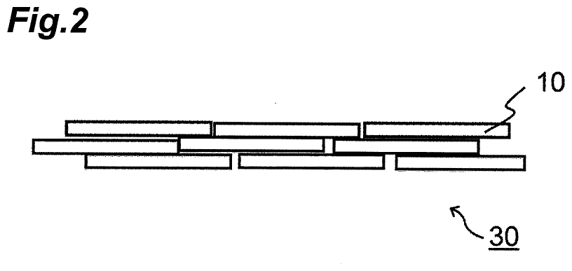

### DETAILED DESCRIPTION

Hereinafter, a film and a method for producing the same according to one embodiment of the present disclosure will be described.

In some aspects, a film of the present disclosure is a film comprising two-dimensional particles, wherein the two-dimensional particles are two-dimensional particles having a plurality of layers, and comprise N-methylformamide,
wherein at least one of the plurality of layers comprises a layer body represented by a formula:

MₘXₙ
wherein “M” is at least one Group 3, 4, 5, 6, or 7 metal,
   “X” is a carbon atom, a nitrogen atom, or a combination thereof,
   “n” is 1 to 4, and
   “m”>“n” and ‘m”≤5; and
at least one modifier or terminal “T” is present on a surface of the layer body, wherein each “T” is a hydroxyl group, a fluorine atom, a chlorine atom, an oxygen atom, or a hydrogen atom,
the N-methylformamide is disposed between two adjacent layers of the plurality of layers, and
a content of the N-methylformamide in the film is 0.104 mol or more with respect to 1 mol of MₘXₙ.

In some aspects, the film of the present disclosure suppresses a decrease in conductivity with time, and preferably suppresses a decrease in conductivity with time even under high temperature and high humidity. Although not to be construed as being limited to a specific theory, N-methylformamide is considered to be present in a certain amount between the layers comprised in the two-dimensional particles in the film of the present disclosure, and a hydrogen bond between hydrogen bonding group comprised in N-methylformamide and the modifier or terminal “T” of the layer may be formed. Therefore, the N-methylformamide is considered to be stably present between the layers, the ingress of water into the layers is suppressed, and an increase in an interlayer distance is also suppressed. As a result, a conductivity decrease due to an increase in the interlayer distance can be suppressed.

In the present disclosure, when an element is referred to as an “atom”, the oxidation number of the element is not limited to zero, and may be any number within the range of possible oxidation numbers of the element.

In the present disclosure, the two-dimensional particles may be understood as a layered material or layered compound, and is also represented as “MₘXₙTₛ”, wherein “s” is any number, and conventionally “x” or “z” may be used instead of “s.” Typically, “n” can be 1, 2, 3, or 4, but is not limited thereto.

In the present disclosure, the layer may be referred to as an MXene layer, and the two-dimensional particles may be referred to as MXene two-dimensional particles or MXene particles.

In the above formula of MXene, “M” is preferably at least one selected from the group consisting of Ti, Zr, Hf, V, Nb, Ta, Cr, Mo, and Mn, and more preferably at least one selected from the group consisting of Ti, V, Cr, and Mo.

MXenes whose above formula MₘXₙ is expressed as below include, for example:
Sc₂C, Ti₂C, Ti₂N, Zr₂C, Zr₂N, Hf₂C, Hf₂N, V₂C,
V₂N, Nb₂C, Ta₂C, Cr₂C, Cr₂N, Mo₂C, Mo_{1.3}C, Cr_{1.3}C, (Ti,V)₂C, (Ti,Nb)₂C, W₂C, W_{1.3}C, Mo₂N, Nb_{1.3}C, Mo_{1.3}Y_{0.6}C (in the above formula, “1.3” and “0.6” mean about 1.3 (4/3) and about 0.6 (=2/3), respectively),
Ti₃C₂, Ti₃N₂, Ti₃(CN), Zr₃C₂, (Ti,V)₃C₂, (Ti₂Nb)C₂, (Ti₂Ta)C₂, (Ti₂Mn)C₂, Hf₃C₂, (Hf₂V)C₂, (Hf₂Mn)C₂, (V₂Ti)C₂, (Cr₂Ti)C₂, (Cr₂V)C₂,
(Cr₂Nb)C₂, (Cr₂Ta)C₂, (Mo₂Sc)C₂, (Mo₂Ti)C₂,
(Mo₂Zr)C₂, (Mo₂Hf)C₂, (Mo₂V)C₂, (Mo₂Nb)C₂, (Mo₂Ta)C₂, (W₂Ti)C₂, (W₂Zr)C₂, (W₂Hf)C₂,
Ti₄N₃, V₄C₃, Nb₄C₃, Ta₄C₃, (Ti,Nb)₄C₃, (Nb,Zr)₄C₃, (Ti₂Nb₂)C₃, (Ti₂Ta₂)C₃, (V₂Ti₂)C₃, (V₂Nb₂)C₃, (V₂Ta₂)C₃, (Nb₂Ta₂)C₃, (Cr₂Ti₂)C₃,
(Cr₂V₂)C₃, (Cr₂Nb₂)C₃, (Cr₂Ta₂)C₃, (Mo₂Ti₂)C₃, (Mo₂Zr₂)C₃, (Mo₂Hf₂)C₃, (Mo₂V₂)C₃, (Mo₂Nb₂)C₃, (Mo₂Ta₂)C₃, (W₂Ti₂)C₃, (W₂Zr₂)C₃, (W₂Hf₂)C₃, (Mo₂0.7V_{1.3})C₃ (in the above formula, “2.7” and “1.3” mean about 2.7 (=8/3) and about 1.3 (=4/3), respectively)

Typically in the above formula, “M” can be titanium or vanadium and “X” can be a carbon atom or a nitrogen atom. For example, a MAX phase may be Ti₃AlC₂, the layer body may be Ti₃C₂, and MXene may be Ti₃C₂Tₛ (in other words, “M” is Ti, “X” is C, “n” is 2, and “m” is 3).

In the present disclosure, MXene may comprise “A” atoms derived from the MAX phase of the precursor at a relatively small amount, for example, 10% by mass or less with respect to the original amount of the “A” atoms. The remaining amount of the “A” atoms may be preferably 8% by mass or less, and more preferably 6% by mass or less, with respect to the original “A” atoms. However, even if the remaining amount of the “A” atoms exceeds 10% by mass, there may be no problem depending on the application and use conditions of the two-dimensional particles.

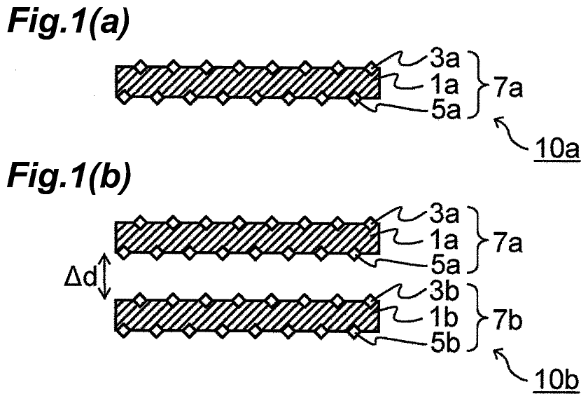

The two-dimensional particles are an aggregate comprising MXene particles (hereinafter, simply referred to as “MXene particles”)10a (single-layer MXene particles) as one layer schematically exemplified in FIG. 1(a). More specifically, the MXene particles 10a are an MXene layer 7a comprising a layer body (MₘXₙ layer) la represented by MₘXₙ and modifiers or terminals T3a and 5a existing on the surface (more specifically, at least one of two surfaces facing each other in each layer) of the layer body 1a. Therefore, the MXene layer 7a is also represented by “MₘXₙTₛ” wherein s is any number. In FIG. 1(a), N-methylformamide is not shown.

The two-dimensional particles may comprise one or plural layers. Examples of the MXene particles (multilayer MXene particles) comprising the plurality of layers comprise, but are not limited to, MXene particles 10b comprising two layers as schematically shown in FIG. 1(b). 1b, 3b, 5b, and 7b in FIG. 1(b) are the same as 1a, 3a, 5a, and 7a in FIG. 1(a) described above. Two adjacent MXene layers (for example, 7a and 7b) of the multilayer MXene particles may not necessarily be completely separated from each other, but may be partially in contact with each other. The MXene particles 10a may be a mixture of the single-layer MXene particles 10a and the multilayer MXene particles 10b, in which the multilayer MXene particles 10b are individually separated and present as one layer and the multilayer MXene particles 10b that are not separated remain. In FIG. 1(b), N-methylformamide is not shown.

Although the present embodiment is not limited, the thickness of each layer (corresponding to the MXene layers 7a and 7b) in the MXene particles may be, for example, 0.8 nm to 5 nm, and particularly 0.8 nm to 3 nm (may mainly vary depending on the number of “M” atomic layers in each layer). For individual laminates of the multilayer MXene particles that may be comprised, an interlayer distance (alternatively, a void dimension, indicated by Δd in FIG. 1(b)) may be, for example, 0.8 nm to 10 nm, particularly 0.8 nm to 5 nm, and more particularly 0.8 nm to 1.5 nm. The total number of layers may be 2 to 20,000.

In one aspect, in the two-dimensional particles according to the present embodiment, it is preferable that the multilayer MXene particles that can be comprised comprise two-dimensional particles obtained through a delamination process and having a small number of layers. The term “small number of layers” means that, for example, the number of laminated MXene layers is 6 or less. The thickness of the multilayer MXene particles having a small number of layers in the lamination direction is preferably 15 nm or less, and more preferably 10 nm or less. Hereinafter, the “multilayer MXene particles having a small number of layers” may be referred to as “few-layer MXene particles”. The single-layer MXene particles and the few-layer MXene particles may be collectively referred to as “single-layer/few-layer MXene particles”. By comprising the single-layer/few-layer MXene particles, the conductivity of the resulting film can be increased.

In some aspects, the two-dimensional particles according to the present embodiment preferably comprise single-layer MXene particles and few-layer MXene particles, that is, single-layer/few-layer MXene particles. In the two-dimensional particles of the present embodiment, the ratio of the single-layer/few-layer MXene particles having a thickness of 15 nm or less is preferably 90 vol % or more, and more preferably 95 vol % or more.

In one aspect, the ratio of (the average value of the major axes of the two-dimensional surfaces of the two-dimensional particles)/(the average value of the thicknesses of the two-dimensional particles) is 1.2 or more, preferably 1.5 or more, and more preferably 2 or more. The average value of the major axes of the two-dimensional surfaces of the two-dimensional particles and the average value of the thicknesses of the two-dimensional particles may be obtained by a method described later.

### Average Value of Major Axes of Two-Dimensional Surfaces of Two-Dimensional Particles

In the two-dimensional particles of the present embodiment, the average value of the major axes of the two-dimensional surfaces is preferably 1 m to 20 m. Hereinafter, the average value of the major axes of the two-dimensional surfaces may be referred to as “average flake size”.

The conductivity of the film increases as the average flake size increases. Since the two-dimensional particles of the present embodiment have a large average flake size of 1.0 m or more, a film formed using the two-dimensional particles, for example, a film obtained by laminating the two-dimensional particles can achieve a conductivity of 2000 S/cm or more. The average value of the major axes of the two-dimensional surfaces is preferably 1.5 m or more, and more preferably 2.5 m or more. When the delamination treatment of MXene is performed by subjecting MXene to ultrasonic treatment, most of MXene is reduced in diameter to about several hundred nanometers in terms of major axis by the ultrasonic treatment, so that the film formed of the single-layer MXene delaminated by the ultrasonic treatment is considered to have lower conductivity.

The average value of the major axes of the two-dimensional surfaces is 20 m or less, preferably 15 m or less, and more preferably 10 m or less from the viewpoint of dispersibility in a dispersion medium.

As illustrated by the Examples described later, the major axis of the two-dimensional surface refers to a major axis when each MXene particle is approximated to an elliptical shape in an electron micrograph, and the average value of the major axes of the two-dimensional surfaces refers to the number average of the major axes of 80 particles or more. As an electron microscope, a scanning electron microscope (SEM) photograph or a transmission electron microscope (TEM) photograph can be used.

The average value of the major axes of the two-dimensional particles of the present embodiment may be measured in a state where a film comprising the two-dimensional particles is dissolved in a solvent and the two-dimensional particles are dispersed in the solvent. Alternatively, the average value of the major axes of the two-dimensional particles may be measured from the SEM image of the film.

### Average Value of Thicknesses of Two-Dimensional Particles

The average value of the thicknesses of the two-dimensional particles of the present embodiment is preferably 1 nm to 15 nm. The thickness is preferably 10 nm or less, more preferably 7 nm or less, and still more preferably 5 nm or less. Meanwhile, considering the thickness of the single-layer MXene particles, the lower limit of the thickness of the two-dimensional particles can be 1 nm.

The average value of the thicknesses of the two-dimensional particles is obtained as a number average dimension (for example, a number average of at least 40 particles) based on an atomic force microscope (AFM) photograph or a transmission electron microscope (TEM) photograph.

In some aspects, the two-dimensional particles comprise N-methylformamide. N-methylformamide is disposed between two of the layers adjacent to each other in the two-dimensional particles. Here, both two of the layers adjacent to each other may be comprised in single two-dimensional particles having a plurality of layers, one of which may be comprised in two-dimensional particles having one or plural layers, and the other may be comprised in the other two-dimensional particles having one or plural layers. For example, N-methylformamide may exist on the surface of the two-dimensional particles. That is, N-methylformamide may be present in contact with the layer on the surface side of the layer located on the outermost surface of the two-dimensional particles. Even in this case, N-methylformamide is considered to form a hydrogen bond between the outermost layer of one two-dimensional particle and the outermost layer of the other two-dimensional particle, and N-methylformamide is considered to contribute to the suppression of a decrease in conductivity with time and the suppression of a decrease in conductivity with time even under high temperature and high humidity.

Although not to be construed as being limited to a specific theory, N-methylformamide is considered to have, as a hydrogen bonding group, a secondary amino group (—NH—) corresponding to a hydrogen donor and an oxygen atom (O═) corresponding to a hydrogen acceptor, and easily forms a hydrogen bond with the modifier or terminal T of the layer in the two-dimensional particles. Therefore, N-methylformamide is considered to be stably present between the layers of the two-dimensional particles, and therefore suppress the ingress of water into the layers, which sustains a multilayer structure at the same time.

The presence of N-methylformamide between the layers in the two-dimensional particles can be confirmed by measuring an interlayer distance (d₀₀₂) by X-ray diffraction measurement (XRD). When N-methylformamide is present between the layers in the two-dimensional particles, the interlayer distance (d₀₀₂) can be, for example, 1.1 nm to 1.5 nm, and further 1.2 nm to 1.4 nm. Meanwhile, in the two-dimensional particles not sufficiently comprising N-methylformamide, the interlayer distance (d₀₀₂) can be, for example, 0.8 nm or more and less than 1.1 nm, and can be distinguished from the two-dimensional particles comprising N-methylformamide.

The half-value width of a peak corresponding to d₀₀₂ in the two-dimensional particles (1) may be, for example, 0° to 0.5°, preferably 0° to 0.3°, and may be 0.1° or more as 20. In the two-dimensional particles (1), the half-value width of the peak corresponding to d₀₀₂ is in the above range, and the interlayer distance is presumed to be set.

The content of N-methylformamide in the film of the present embodiment is 0.104 mol or more with respect to 1 mol of MₘXₙ. As a result, the ingress of water into between the layers of the two-dimensional particles is considered to be sufficiently suppressed. The content of N-methylformamide in the film of the present embodiment may be preferably 0.104 mol to 0.5 mol, and more preferably 0.12 mol to 0.3 mol, with respect to 1 mol of MₘXₙ.

The content of N-methylformamide in the film of the present embodiment can be measured by thermogravimetric analysis (TG), and for example, when the temperature is raised from 150° C. to 450° C. at 10° C./min or 20° C./min, a difference between a mass at 150° C. and a mass at 450° C. may be taken as the content of N-methylformamide. Assuming that a mass before the temperature is raised to 150° C. or higher is the mass of MₘXₙ, the substance amount of MₘXₙ can be calculated by dividing the mass by the formula amount of MₘXₙ.

### Second Embodiment: Method for Producing Two-Dimensional Particles

Hereinafter, a method for producing two-dimensional particles according to one embodiment of the present disclosure will be described in detail, but the present disclosure is not limited to such an embodiment.

In some aspects, a method for producing two-dimensional particles of the present embodiment, comprises:
(a) preparing a predetermined precursor;
(b) removing at least a part of A atoms from the precursor using an etching solution to obtain an etched product;
(c) cleaning the etched product to obtain an etched cleaned product;
(d) mixing the etched cleaned product with an intercalator to obtain an intercalated product;
(e) stirring the intercalated product to obtain a delaminated product in which the intercalated product is delaminated,
(f) mixing the delaminated product with N-methylformamide to prepare a mixture (slurry) comprising the two-dimensional particles, and
(g) optionally, drying the delaminated product before being mixed with N-methylformamide.

Hereinafter, each step will be described in detail.

Step (a) may comprise but is not limited to the following steps and/or parameters:

First, a predetermined precursor is prepared. The predetermined precursor that can be used in the present embodiment is a MAX phase that is a precursor of MXene, and is represented by a formula below:

MₘAXₙ
wherein “M” is at least one metal of Group 3, 4, 5, 6, or 7 and comprises at least Ti,
“X” is a carbon atom, a nitrogen atom, or a combination thereof,
“A” is at least one element of Group 12, 13, 14, 15, or 16,
“n’ is 1 to 4,
“m”>“n” and “m”≤5.

The above “M”, “X”, “n”, and “m” are as described above.

“A” is at least one element of Group 12, 13, 14, 15, and 16, is usually an element of Group A, typically of Group IIIA and Group IVA, and more specifically may comprise at least one selected from the group consisting of Al, Ga, In, Tl, Si, Ge, Sn, Pb, P, As, S, and Cd, and is preferably Al.

The MAX phase has a crystal structure in which a layer constituted by the A atoms is located between two layers represented by MₘXₙ (each “X” may have a crystal lattice located in an octahedral array of “M”). When typically “m”=“n”+1, but not limited thereto, the MAX phase comprises repeating units in which each one layer of “X” atoms is disposed in between adjacent layers of “n”+1 layers of “M” atoms (these are also collectively referred to as an “MₘXₙ layer”), and a layer of “A” atoms (“A atom layer”) is disposed as a layer next to the (“n”+1)th layer of “M” atoms.

The MAX phase can be produced by a known method. For example, TiC powder, Ti powder, and Al powder are mixed in a ball mill, and the resulting mixed powder is calcined under an Ar atmosphere to obtain a calcined body (block-shaped MAX phase). Thereafter, the obtained calcined body can be pulverized by an end mill to obtain a powdery MAX phase for the next step.

Step (b) may comprise but is not limited to the following steps and/or parameters:

Instep (b), etching treatment for removing at least apart of the “A” atoms from MₘAXₙ of the precursor by etching is performed using an etching solution. As a result, a treated product in which at least a part of the layer composed of “A” atoms is removed is obtained while the layer represented by MₘXₙ in the precursor is maintained.

The etching solution may comprise an acid such as HF, HCl, HBr, HI, sulfuric acid, phosphoric acid, or nitric acid, and typically, an etching solution comprising F atoms can be used. Examples of the etching solution include a mixed solution of LiF and hydrochloric acid; a mixed solution of hydrofluoric acid and hydrochloric acid; and a mixed solution comprising hydrofluoric acid, and these mixed solutions may further comprise phosphoric acid or the like. The etching solution can be typically an aqueous solution.

As the etching operation using the etching solution and other conditions, conventional conditions can be adopted.

Step (c) may comprise but is not limited to the following steps and/or parameters:

Instep (c), the treated product obtained by the etching treatment is cleaned to obtain an etched cleaned product. By performing cleaning, the acid and the like used in the etching treatment can be sufficiently removed.

The cleaning can be performed using a cleaning liquid, and typically, can be performed by mixing the etched product and the cleaning liquid. The cleaning liquid typically comprises water, and preferably pure water. Meanwhile, a small amount of hydrochloric acid or the like may be further comprised in addition to the pure water. The amount of the cleaning liquid to be mixed with the etched product and the method for mixing the etched product and the cleaning liquid are not particularly limited. For example, as the mixing method, stirring, centrifugation, and the like are performed in a state where the etched product and the cleaning liquid coexist. Examples of the stirring method include a stirring method using a handshake, an automatic shaker, a share mixer, a pot mill, or the like. The degree of stirring such as a stirring speed or a stirring time may be adjusted according to the amount, concentration, and the like of the etched product to be treated. The cleaning with the cleaning liquid may be performed once or more, and the cleaning with the cleaning is preferably performed a plurality of times. For example, specifically, the cleaning with the cleaning liquid may be performed by sequentially performing step (i) (to the treated product or the remaining precipitate obtained in the following (iii)), adding the cleaning liquid, followed by stirring, step (ii) centrifuging the stirred product, and step (iii) discarding a supernatant liquid after centrifugation, and the steps (i) to (iii) are repeated within a range of 2 times or more, for example, 15 times or less.

Step (d) may comprise but is not limited to the following steps and/or parameters:

Instep (d), intercalation treatment is performed using an intercalator to obtain an intercalated product.

Examples of the intercalator include a metal compound comprising a metal cation, an organic compound, and an organic salt.

The metal cation may be the same as the metal cation comprised in the two-dimensional particles.

Examples of the metal compound include anionic compound in which the metal cation and the anion are bonded. Examples of the ionic compound include an iodide, a phosphate, a sulfate comprising a sulfide salt, a nitrate, an acetate, and a carboxylate of the metal cation. As the metal cation, an alkali metal ion and an alkaline earth metal cation are preferable, and a lithium ion is more preferable. As the metal compound, a metal compound comprising an alkali metal ion or an alkaline earth metal ion is preferable, a metal compound comprising a lithium ion is more preferable, an ionic compound of a lithium ion is still more preferable, and one or more of an iodide, a phosphate, and a sulfide salt of a lithium ion are particularly preferable. When a lithium ion is used as the metal ion, since the water hydrated to the lithium ion is considered to have the most negative dielectric constant, a monolayer can be formed readily.

When a metal compound comprising a metal cation is used as the intercalator, the metal cation can be intercalated with respect to the etched cleaned product. As a result, an intercalated product in which the metal cation is intercalated between two of MₘXₙ layers adjacent to each other is obtained.

The organic compound can be dissolved or mixed in water. The solubility of the organic compound in water is 5 g/100 g H₂O or more, and more preferably 10 g/100 g H₂O or more at 25° C. In the present specification, the solubility of the organic compound in the case of being incorporated in water is treated as infinite.

The organic compound is preferably a highly polar compound. In the present specification, the compound having high polarity is a concept comprising not only a compound exhibiting clear charge separation but also a compound having high hydrophilicity. The polarity of the compound can be evaluated using a solubility parameter as an index. The Hildebrand solubility parameter (also referred to as “SP value”) of the organic compound is 19.0 MPa1/2 or more. The SP value of the organic compound is preferably equal to or less than the SP value of water, and is 47.8 MPa1/2 or less. The SP value is a value serving as an index of the polarity of the compound. As the SP value is larger, the polarity is higher, and compounds having close SP values tend to be compatible with each other.

The boiling point of the organic compound is, for example, 285° C. or lower, preferably 240° C. or lower, more preferably 200° C. or lower, and is, for example, 50° C. or higher.

The molecular weight of the organic compound is, for example, 500 or less, preferably 300 or less, more preferably 200 or less, and is, for example, 30 or more.

Examples of the organic compound include an organic compound having one or more of a carbonyl group, an ester group, an amide group, a formamide group, a carbamoyl group, a carbonate group, an aldehyde group, an ether group, a sulfonyl group, a sulfinyl group, a hydroxyl group, a cyano group, and a nitro group. Specific examples of the organic compound include alcohols such as methanol (MeOH), ethanol (EtOH), and 2-propanol; sulfone compounds such as sulfolane; sulfoxides such as dimethyl sulfoxide (DMSO); carbonates such as propylene carbonate (PC); amides such as N-methylformamide (NMF), N,N-dimethylformamide, N-methylpyrrolidone (NMP), and dimethylacetamide (DMAc); Ketones such as acetone and methyl ethyl ketone (MEK); and tetrahydrofuran (THF).

When the organic compound is used as the intercalator, the organic compound can be intercalated with respect to the etched cleaned product. As a result, an intercalated product in which the organic compound is intercalated between two of MₘXₙ layers adjacent to each other is obtained.

Examples of the organic salt include an organic salt comprising an organic cation and an anion. Examples of the organic cation include an ammonium cation, and examples of the anion include a hydroxide ion and a chloride ion. Examples of the organic salt include an ammonium salt. Specific examples of the organic salt include tetramethylammonium hydroxide (TMAOH), tetraethylammonium hydroxide (TEAOH), and tetrabutylammonium chloride.

When the organic salt is used as the intercalator, the organic cation constituting the organic salt can be intercalated with respect to the etched cleaned product. As a result, an intercalated product in which the organic cation is intercalated between two of MₘXₙ layers adjacent to each other is obtained.

The intercalation treatment may be performed in a dispersion medium. The specific method of the intercalation treatment is not particularly limited, and for example, the etched cleaned product and the metal compound may be mixed and stirred, or may be left to stand. For example, stirring at room temperature can be exemplified. Examples of the stirring method include a method using a stirring bar such as a stirrer, a method using a stirring blade, a method using a mixer, and a method using a centrifugal device. The stirring time can be set according to the production scale of the single-layer/few-layer MXene particles, and can be set, for example, to 12 to 24 hours.

The intercalation treatment may be performed in the presence of a dispersion medium. Examples of the dispersion medium include water; and organic media such as N-methylpyrrolidone, N-methylformamide, N,N-dimethylformamide, methanol, ethanol, dimethylsulfoxide, ethylene glycol, and acetic acid.

The order of mixing the dispersion medium, the etched cleaned product, and the metal compound is not particularly limited, but in one aspect, the dispersion medium and the etched cleaned product may be mixed, followed by mixing the mixture with the metal compound. Typically, the etching solution after the etching treatment may be used as the dispersion medium.

The intercalation treatment can be typically performed on the etched cleaned product, but in another aspect, the intercalation treatment may be performed on the precursor simultaneously with the etching treatment. Specifically, the etching and intercalation treatments comprise mixing a precursor, an etching solution, and a metal compound comprising a metal cation to remove at least a part of A atoms from the precursor, and intercalating the precursor with the metal cation from which the A atoms have been removed to obtain an intercalated product. As a result, at least a part of the A atoms are removed from the precursor (MAX), the MₘXₙ layer in the precursor remains, and an intercalated product in which the metal cation is intercalated between the plurality of MₘXₙ layers adjacent to each other is obtained.

As the etching solution and the metal compound used in the etching and intercalation treatments, the same etching solution and metal compound as those used in the step (b) can be used, respectively.

Step (e) may comprise but is not limited to the following steps and/or parameters:

In step (e), the intercalated product is stirred, and delamination treatment for delaminating the intercalated product is performed to obtain a delaminated product. By the stirring, a shear stress is applied to the intercalated product, and at least a part between two of MₘXₙ layers adjacent to each other can be peeled off, and the MXene particles can be formed into a single-layer or a few-layer.

Conditions for the delamination treatment are not particularly limited, and the delamination treatment can be performed by a known method. Examples of a method for applying a shear stress to the intercalated product include a method for dispersing the intercalated product in a dispersion medium and stirring the dispersion medium. Examples of the stirring method include stirring using a mechanical shaker, a vortex mixer, a homogenizer, ultrasonic treatment, a handshake, an automatic shaker, or the like. The degree of stirring such as a stirring speed and a stirring time may be adjusted according to the amount, concentration, and the like of the treated product to be treated. For example, the slurry after the intercalation is centrifuged to discard the supernatant liquid, and then pure water is added to the remaining precipitate, followed by stirring by, for example, a handshake or an automatic shaker to perform layer separation (delamination). The removal of the unpeeled substance comprises a step of performing centrifugal separation to discard the supernatant, and then cleaning the remaining precipitate with water. For example, (i) pure water is added to the remaining precipitate after discarding the supernatant, followed by stirring, (ii) centrifugation is performed, and (iii) the supernatant liquid is recovered. The operations of (i) to (iii) are repeated 1 time or more, preferably 2 times or more and 10 times or less to obtain a supernatant liquid comprising single-layer/few-layer MXene particles as a delaminated product. Alternatively, the supernatant liquid may be centrifuged, and the supernatant liquid after centrifugation may be discarded to obtain a clay comprising the single-layer/few-layer MXene particles as the delaminated product.

The delaminated product may be further cleaned before being subjected to the next step.

In one aspect, the cleaning can be performed using a cleaning liquid, and typically, can be performed by mixing the delaminated product and the cleaning liquid. In another aspect, the cleaning can be performed by acid-treating the delaminated product and then mixing the acid-treated product with the cleaning liquid. As the acid used for acid treatment, inorganic acids such as hydrochloric acid, sulfuric acid, nitric acid, phosphoric acid, perchloric acid, hydroiodic acid, hydrobromic acid, and hydrofluoric acid; and organic acids such as acetic acid, citric acid, oxalic acid, benzoic acid, and sorbic acid may be appropriately used, and the concentration of the acid in the acid solution can be appropriately adjusted according to the delaminated product. The cleaning with the cleaning liquid may be performed by sequentially performing step (i) (to the treated product or the remaining precipitate obtained in the following (iii)), adding the cleaning liquid, followed by stirring, step (ii) centrifuging the stirred product, and step (iii) discarding a supernatant liquid after centrifugation, and the steps (i) to (iii) are repeated within a range of 2 times or more, for example, 15 times or less. The stirring can be performed using a handshake, an automatic shaker, a share mixer, a pot mill, or the like. The acid treatment may be performed one or more times, and if necessary, an operation of mixing with a fresh acid solution (acid solution not used for the acid treatment) and stirring may be performed within a range of two or more times, for example, 10 times or less. As the cleaning liquid, the same cleaning liquid as that in the step (c) can be used. For example, specifically, water may be used as the cleaning liquid, and pure water is preferable. The mixing can be performed by the same method as the mixing method in the step (c), and specific examples thereof include stirring and centrifugation. Examples of the stirring method include a stirring method using a handshake, an automatic shaker, a share mixer, a pot mill, or the like.

Step (f) may comprise but is not limited to the following steps and/or parameters:

In step (f), the delaminated product and N-methylformamide are mixed. Thereby, N-methylformamide can be inserted in between the layers. In the step (f), the mixing of the delaminated product and N-methylformamide means mixing from a state where the delaminated product and N-methylformamide are completely separated to a state where N-methylformamide can be present in the delaminated product. For example, the mixing of the delaminated product and N-methylformamide may comprise stirring the undried delaminated product and N-methylformamide, and permeating N-methylformamide into the dried delaminated product.

The method for mixing the delaminated product and N-methylformamide is not particularly limited, and the delaminated product and N-methylformamide can be mixed by a known method. Examples thereof include a method in which N-methylformamide and the delaminated product are stirred and dispersed. Examples of the stirring method include stirring using a mechanical shaker, a vortex mixer, a homogenizer, ultrasonic treatment, a handshake, an automatic shaker, or the like. The degree of stirring such as a stirring speed and a stirring time may be adjusted according to the amount, concentration, and the like of the treated product to be treated. Examples of the mixing method include permeating N-methylformamide into the dried product of the delaminated product. Such permeation can be performed, for example, by immersing the dried product of the delaminated product in N-methylformamide. In one aspect, the content of the delaminated product in the mixture comprising the delaminated product and N-methylformamide can be, for example, 0.5% by mass to 10% by mass, and further 1% by mass to 5% by mass.

When the delaminated product and N-methylformamide are mixed, other dispersion medium may coexist. Specific examples of the other dispersion medium comprise water. N-methylformamide and the other dispersion medium may be mixed so that the volume ratio of N-methylformamide and the other dispersion medium (N-methylformamide/other dispersion medium) is, for example, 50/50 or more, and preferably 55/45 or more.

Step (g) may comprise but is not limited to the following steps and/or parameters:

In step (g), the delaminated product may be dried before being subjected to the step (f). Accordingly, moisture comprised in the delaminated product can be removed.

Hereinafter, a material obtained by drying the delaminated product is also referred to as a dried product.

The drying method may be performed under mild conditions such as natural drying (typically, the delaminated product is disposed in an air atmosphere at room temperature and normal pressure) and air drying (blowing air), or may be performed under relatively active conditions such as hot air drying (blowing heated air), heat drying, vacuum drying, and/or freeze drying. In the step (g), it is preferable to remove water comprised in the delaminated product as much as possible, and from this viewpoint, it is preferable to dry the delaminated product under active conditions. In the step (g), it is preferable to remove water without heating to a high temperature. For example, a drying temperature in the step (g) may be preferably 190° C. or lower, more preferably 150° C. or lower, further 140° C. or lower, and particularly 120° C. or lower. In one aspect, the temperature may be lower than 20° C., and further may be 10° C. or lower. From this viewpoint, the drying method is preferably vacuum drying and/or freeze drying, and more preferably freeze drying.

In the drying in the present step, the dispersion medium can be removed from the delaminated product, and a film-like dried product is typically obtained.

In the case of comprising the step (g), for example, the method for producing two-dimensional particles may comprise:
(f) preparing a predetermined precursor;
(g) removing at least a part of A atoms from the precursor using an etching solution to obtain an etched product;
(h) cleaning the etched product to obtain an etched cleaned product;
(i) mixing the etched cleaned product with an intercalator to obtain an intercalated product; and
(j) stirring the intercalated product to obtain a delaminated product in which the intercalated product is delaminated;
(k) drying the delaminated product to obtain a dried product; and
(fl) permeating N-methylformamide into the dried product of the delaminated product.

In such an aspect, when N-methylformamide is permeated into the dried product of the delaminated product, the amount of the dried product of the delaminated product can be, for example, 0.5 parts by mass or more and 10 parts by mass or less, and further 1 part by mass or more and 5 parts by mass or less with respect to 100 parts by mass of N-methylformamide.

In one aspect, the content of the two-dimensional particles in the film of the present embodiment may be preferably 70 vol % or more and 100 vol % or less, more preferably 90 vol % or more and 100 vol % or less, and still more preferably 95 vol % or more and 100 vol % or less.

In one aspect, the film of the present embodiment may further comprise a resin in addition to the two-dimensional particles. Examples of the resin include an acrylic resin, a polyester resin, a polyamide resin, a polyimide resin, a polyamideimide resin, a polyolefin resin, a polycarbonate resin, a polyurethane resin, a polystyrene resin, a polyether resin, polylactic acid, and polyvinyl alcohol.

The film may further comprise other additives.

A method for producing a film according to the present embodiment comprises forming the film using the two-dimensional particles, and in one aspect, comprises:
(l) preparing a predetermined precursor;
(m) removing at least a part of A atoms from the precursor using an etching solution to obtain an etched product;
(n) cleaning the etched product to obtain an etched cleaned product;
(o) mixing the etched cleaned product with a metal compound comprising a metal cation to obtain an intercalation product in which the metal cation is intercalated with the etched cleaned product;
(p) stirring the intercalated product to obtain a delaminated product in which the intercalated product is delaminated;
(q) mixing the delaminated product with N-methylformamide to obtain a mixed solution;
(r) forming a precursor film using the mixed solution; and
(s) drying the precursor film under normal pressure to form the film.

In another aspect, the method for producing a film according to the present embodiment may comprise:
(t) preparing a predetermined precursor;
(u) removing at least a part of A atoms from the precursor using an etching solution to obtain an etched product;
(v) cleaning the etched product to obtain an etched cleaned product;
(w) mixing the etched cleaned product with a metal compound comprising a metal cation to obtain an intercalation product in which the metal cation is intercalated with the etched cleaned product;
(x) stirring the intercalated product to obtain a delaminated product in which the intercalated product is delaminated;
(y) drying the delaminated product to obtain a dried product;
(fl) permeating N-methylformamide into the dried product of the delaminated product to form a precursor film; and
(i) drying the precursor film under normal pressure to form the film.

The mixed solution in the step (f) comprises the delaminated product and/or the dried product and N-methylformamide, and may further comprise the resin as necessary. The precursor film can be formed by, for example, subjecting the mixed solution to suction filtration, or applying the mixed solution and drying the applied mixed solution under normal pressure once or twice or more.

Examples of the method for applying the mixed solution include a method for applying the mixed solution by spraying. The spraying method may be, for example, an airless spraying method or an air spraying method, and specific examples thereof include a spraying method using a nozzle such as a one-fluid nozzle, a two-fluid nozzle, or an air brush.

The mixed solution may comprise a dispersion medium other than N-methylformamide. Specific examples of the other dispersion medium include water. N-methylformamide and the other dispersion medium may be mixed so that the volume ratio of N-methylformamide and the other dispersion medium (N-methylformamide/other dispersion medium) is, for example, 50/50 or more, and preferably 55/45 or more.

In one aspect, the precursor film can be dried under normal pressure. The precursor film comprises two-dimensional particles, N-methylformamide, and other dispersion medium used as necessary, and at least a part of N-methylformamide comprised in the precursor film and other dispersion medium that can be comprised is removed by drying the precursor film, whereby a film can be obtained. The performing under normal pressure means performing under a condition in which decompression treatment or pressurization treatment is not performed. In one aspect, the normal pressure can be 900 hPa to 1,200 hPa as an absolute pressure, and further can be 950 hPa to 1,160 hPa as an absolute pressure. A drying temperature may be, for example, 190° C. or lower, preferably 150° C. or lower, more preferably 140° C. or lower, still more preferably 120° C. or lower, yet still more preferably 110° C. or lower, and is, for example, 80° C. or higher, preferably 90° C. or higher. A drying time is, for example, 30 minutes or more and 10 hours or less, and preferably 1 hour or more and 5 hours or less.

By drying the dispersion medium under such conditions, a film in which N-methylformamide is present between the layers of the two-dimensional particles can be easily produced.

Examples of the application using the film of the present embodiment include an electrode. The electrode is not limited to a specific form as long as the electrode comprises the film. Examples of the electrode include an electrode in a solid state and a flexible electrode in a soft state.

In the electrode of the present embodiment, the film may be exposed to the outside air so as to be in direct contact with an object to be measured, or may be covered with a substrate and/or a protective layer or the like.

When the electrode of the present embodiment has a substrate, the film and the substrate may be in direct contact with each other. The material of the substrate is not particularly limited, and may be, for example, an inorganic material such as ceramic or glass, or an organic material. Examples of the organic material include flexible organic materials, and specific examples thereof include a thermoplastic polyurethane elastomer (TPU), a PET film, and a polyimide film. The material of the substrate may be a fiber material (for example, a sheet-shaped fiber material) such as paper or cloth.

The protective layer may be a layer covering at least a part or the entire of the film, and may be preferably a layer covering at least a part of the film. The protective layer may be made of an organic material, and specifically may be a resin such as an acrylic resin, a polyester resin, a polyamide resin, a polyimide resin, a polyamideimide resin, a polyolefin resin, a polycarbonate resin, a polyurethane resin, a polystyrene resin, a polyether resin, polylactic acid, or polyvinyl alcohol.

The electrode can be utilized for any suitable application. Examples thereof include a counter electrode and a reference electrode in electrochemical measurement, an electrode for an electrochemical capacitor, an electrode for a battery, a bioelectrode, an electrode for a sensor, and an electrode for an antenna. The electrode can also be utilized in applications where high conductivity is required to be maintained (a decrease in initial conductivity is reduced and oxidation is prevented), such as electromagnetic shielding (EMI shielding). Details of these applications will be described below.

The electrode is not particularly limited, and may be, for example, an electrode for a capacitor, an electrode for a battery, a biological signal sensing electrode, an electrode for a sensor, and an electrode for an antenna, and the like. Usage of the film enables the achievement of a large-capacity capacitor and battery, a low-impedance biological signal sensing electrode, and a highly sensitive sensor and antenna even with a smaller volume (device occupied volume).

The capacitor may be an electrochemical capacitor. The electrochemical capacitor is a capacitor utilizing capacitance developed due to a physicochemical reaction between an electrode (electrode active material) and ions (electrolyte ions) in an electrolytic solution, and can be used as a device (power storage device) that stores electric energy. The battery may be a repeatedly chargeable and dischargeable chemical battery. The battery may be, for example, but not limited to, a lithium ion battery, a magnesium ion battery, a lithium sulfur battery, a sodium ion battery, or the like.

The biological signal sensing electrode is an electrode for acquiring a biological signal. The biological signal sensing electrode may be, for example, but not limited to, an electrode for measuring electroencephalogram (EEG), electrocardiogram (ECG), electromyogram (EMG), electrical impedance tomography (EIT).

The electrode for a sensor is an electrode for detecting a target substance, state, abnormality, or the like. The sensor may be, for example, but not limited to, a gas sensor, a biosensor (a chemical sensor utilizing a molecular recognition mechanism of biological origin), or the like.

The electrode for an antenna is an electrode for emitting an electromagnetic wave into a space and/or receiving an electromagnetic wave in a space. The antenna formed by the electrode for an antenna is not particularly limited, and examples thereof include antennas for mobile communication (antennas for so-called 3G, 4G and 5G) such as mobile phones, antennas for RFID, and antennas for near field communication (NFC).

Although the film and the two-dimensional particles according to one embodiment of the present disclosure have been described in detail above, various modifications are possible. It should be noted that the film and the two-dimensional particles in the present disclosure may be produced by a method different from the producing method according to the above-described embodiment, and the producing methods of the film and the two-dimensional particles in the present disclosure are not limited only to those providing the film and the two-dimensional particles according to the above-described embodiment.

### EXAMPLES

The present disclosure will be described more specifically with reference to the following Examples, but the present disclosure is not limited thereto.

### Example 1

### Preparation of Two-Dimensional Particles

In Example 1, (1) preparation of a precursor (MAX), (2) etching of the precursor, (3) cleaning, (4) intercalation, (5) delamination and cleaning, (6) drying, and (7) mixing with N-methylformamide, which are described in detail below, were sequentially performed to prepare two-dimensional particles.

### (1) Preparation of Precursor (MAX)

TiC powder, Ti powder, and Al powder (all manufactured by Kojundo Chemical Laboratory Co., Ltd.) were placed in a ball mill containing zirconia balls at a molar ratio of 2:1:1 and mixed for 24 hours. The obtained mixed powder was calcined in an Ar atmosphere at 1350° C. for 2 hours. The fired body (block) thus obtained was crushed with an end mill to a maximum size of 40 m or less. Thereby, Ti₃AlC₂ particles were obtained as MAX particles.

### (2) Etching of Precursor (ACID Method)

Using the Ti₃AlC₂ particles (powder) prepared by the above method, etching was performed under the following etching conditions to obtain a solid-liquid mixture (slurry) including a solid component derived from the Ti₃AlC₂ powder.

### Etching Conditions

Precursor: Ti₃AlC₂ (sieving with a mesh size of 45 m)
Etching solution composition: 49% HF 6 mL
   H₂O 18 mL
   HCl (12 M) 36 mL
Amount of precursor charged: 3.0 g
Etching container: 100 mL I Boy
Etching temperature: 35° C.
Etching time: 24 h
Stirrer rotation speed: 400 rpm

### (3) Cleaning

The slurry was divided into two portions, each of which was inserted into each of two 50 mL centrifuge tubes, centrifuged under the condition of 3500 G using a centrifuge. Then, the supernatant liquid was discarded. An operation of adding 40 mL of pure water to the remaining precipitate in each centrifuge tube, centrifuging again at 3500 G, and separating and removing the supernatant liquid was repeated 11 times. After final centrifugation, the supernatant liquid was discarded to obtain a Ti₃C₂Tₓ-moisture medium clay.

### (4) Intercalation

The Ti₃C₂Tₛ-moisture medium clay was stirred at 20° C. or higher and 25° C. or less for 12 hours using LiCl as a Li-containing compound to perform Li intercalation according to the following conditions.

### Conditions of Li Intercalation:

Ti₃C₂Tₓ-moisture medium clay (MXene after cleaning): solid content of 0.75 g
LiCl: 0.75 g
Pure water: 37.2 g
Intercalation container: 100 mL I Boy
Temperature: 20° C. or higher and 25° C. or lower (room temperature)
Time: 10 hours
Stirrer rotation speed: 800 rpm

### (5) Delamination and Cleaning

To the Ti₃C₂Tₓ-moisture medium clay, (i) 40 mL of pure water was added, followed by stirring with a shaker for 15 minutes; (ii) the mixture was centrifuged at 3500 G; and (iii) the supernatant liquid was recovered as a single-layer MXene-containing liquid. The operations (i) to (iii) were repeated four times in total to obtain a single-layer MXene-containing supernatant liquid. Furthermore, this supernatant liquid was centrifuged using a centrifuge under the conditions of 4,300 G and 2 hours, and the supernatant liquid was then discarded to obtain a clay comprising a delaminated product.

### (6) Drying

The clay comprising the delaminated product was frozen for 16 hours, and then freeze-dried for 20 hours to obtain a dried product. A freezing temperature at the time of freezing and freeze drying was −35° C. or lower, and a pressure at the time of freeze drying was 30 Pa or less.

(7) Mixing with N-methylformamide

The dried product and N-methylformamide were mixed so that the content of the dried product in the mixture after mixing was 1.5% by mass. Then, the mixture was dispersed for 15 minutes using an ultrasonic cleaner (AS482 manufactured by AS ONE Corporation) to obtain a slurry comprising two-dimensional particles.

### Preparation of Film

The slurry was placed in a 25 mL syringe, and the syringe was set on a spray coater. Then, a 3 cm square glass substrate (TEMPAX manufactured by SCHOTT) was cleaned with oxygen plasma and set on a stage with suction of a spray coater. The slurry was applied to the cleaned surface and dried with hot air 20 times to prepare a spray film.

### Spray Coating Conditions

Atomization pressure: 0.5 MPa
Distance between nozzle tip and substrate: 15 cm
Liquid delivery amount: 5 mL/s
Sweep speed: 150 mm/s
Stage heater: 100 to 150° C.

The spray film was dried at 100° C. for 2 hours using an atmospheric oven to prepare a film.

### Measurement of Content of N-methylformamide

In an inert gas atmosphere (He gas atmosphere), the temperature was raised from room temperature to 100° C. at a temperature raising rate of 20° C./min, held at 100° C. for 10 minutes, and then raised from 100° C. to 150° C. at a temperature raising rate of 20° C./min using a thermogravimetric analyzer (manufactured by NETZSCH). Thereafter, the temperature was raised from 150° C. to 450° C. at a temperature raising rate of 20° C./min, and the thermogravimetric analysis of the film was performed. The content (mol) of N-methylformamide with respect to 1 mol of Ti₃C₂ was calculated, where a difference between the mass of the film at 150° C. and the mass of the film at 450° C. was defined as the content of N-methylformamide, and the mass of the film at 450° C. was defined as the mass of Ti₃C₂.

Measurement of Interlayer Distance (d₀₀₂)

An interlayer distance (d₀₀₂) was measured as follows.

(a) The film prepared on the glass substrate was cut into a 2 cm square, and subjected to XRD measurement (characteristic X-ray: CuKα 1.541 Å) using an X-ray diffractometer (SmartLab3 and SmartLab Studio II software manufactured by Rigaku Corporation) to obtain an XRD profile of a θ-axis direction scan in the range of 2θ=2 degrees to 50 degrees. A step was 0.02 degrees and a scan speed was 5 degrees/min.

(b) Since a peak corresponding to the (002) plane of MXene (Ti₃C₂Tₛ) appears near 2θ=7 degrees, θ, n=1, and λ=1.541 Å (wavelength of CuKα ray) of the peak were applied to Bragg's equation (2dsinθ=nλ) to obtain the interplanar spacing d₀₀₂ value of the (002) plane as the interlayer distance.

The interlayer distance was 13.2 Å, which was wider than an interlayer distance (10.9 Å) in a film of Comparative Example 4 prepared without using N-methylformamide, and in the two-dimensional particles comprised in the film of Example 1, N-methylformamide was confirmed to be present between the layers.

### Measurement of Conductivity

The conductivity of the obtained film was determined. For the conductivity, the resistivity (Ω) and the thickness (μm) were measured at three points per sample, the conductivity (S/cm) was calculated from these measured values, and the average value of three conductivities obtained by the calculation was adopted. For resistivity measurement, the surface resistance of the film was measured by a four-terminal method using a low resistance conductivity meter (Loresta AX MCP-T370 manufactured by Mitsubishi Chemical Analytech Co., Ltd.). For thickness measurement, a stylus type surface shape measuring apparatus (DEKTAK8 manufactured by Bruker Japan) was used. The thickness immediately before the start of measurement of a change in conductivity described later was defined as a film thickness. Volume resistivity was obtained from the obtained surface resistance and the obtained film thickness of the film, and the reciprocal of the value was taken to obtain the conductivity, which was defined as E₀.

### Measurement of Conductivity Change

The film was placed in a thermo-hygrostat at a relative humidity of 85% and a temperature of 60° C. After standing for 1 day, the conductivity was measured and defined as E. E was divided by E₀ to obtain a conductivity retention ratio.

### Example 2

### Preparation of Two-Dimensional Particles

(1) Preparation of a precursor (MAX), (2) etching of the precursor, (3) cleaning, (4) intercalation, (5) delamination and cleaning were performed in the same manner as in Example 1 to obtain a delaminated product, and then the following step (7) was performed to prepare two-dimensional particles.

(7) Mixing with N-methylformamide

55 parts by volume of N-methylformamide and 45 parts by volume of water were mixed to obtain a mixed dispersion medium, and the delaminated product and the mixed dispersion medium were mixed so that the content of the delaminated product in the mixture after mixing was 1.5% by mass. Thereafter, the mixture was dispersed for 15 minutes using an ultrasonic cleaner (AS482 manufactured by AS ONE Corporation) to obtain a slurry comprising two-dimensional particles.

### Preparation of Film

Using the slurry obtained by the above method, a spray film was prepared in the same manner as in Example 1. The spray film was dried at 100° C. for 2 hours using an atmospheric oven to prepare a film.

### Measurement of Content of N-methylformamide

In an inert gas atmosphere (nitrogen gas atmosphere), the temperature was raised from room temperature to 100° C. at a temperature raising rate of 10° C./min, held at 100° C. for 10 minutes, and then raised from 100° C. to 150° C. at a temperature raising rate of 10° C./min using a thermogravimetric analyzer (manufactured by Hitachi High-Tech Science Corporation).

Thereafter, the temperature was raised from 150° C. to 450° C. at a temperature raising rate of 10° C./min, and the thermogravimetric analysis of the film was performed. The content (mol) of N-methylformamide with respect to 1 mol of Ti₃C₂ was calculated, where a difference between the mass of the film at 150° C. and the mass of the film at 450° C. was defined as the content of N-methylformamide, and the mass of the film at 450° C. was defined as the mass of Ti₃C₂.

Measurement of Interlayer Distance (d₀₀₂)

A correlation distance (d₀₀₂) was measured in the same manner as in Example 1.

The interlayer distance was 13.0 Å, and N-methylformamide was confirmed to be present between the layers in the two-dimensional particles included in the film of Example 2.

### Measurement of Conductivity and Change in Conductivity

Conductivity and a change in conductivity were measured in the same manner as in Example 1.

### Example 3

### Preparation of Two-Dimensional Particles

(1) Preparation of a precursor (MAX), (2) etching of the precursor, (3) cleaning, (4) intercalation, (5) delamination and cleaning, (6) drying, and (7) mixing with N-methylformamide were performed in the same manner as in Example 1 to obtain a slurry comprising two-dimensional particles.

### Preparation of Film

The slurry obtained by the above method was subjected to suction filtration to prepare a filtration film. As a filter for suction filtration, a membrane filter (Durapore manufactured by Merck Corporation, pore diameter: 0.45 m) was used. The filtration film was dried at 100° C. for 2 hours using an atmospheric oven to prepare a film.

### Measurement of Content of N-methylformamide

The content (mol) of N-methylformamide with respect to 1 mol of MₘXₙ was measured in the same manner as in Example 2.

Measurement of Interlayer Distance (d₀₀₂))

A correlation distance (d₀₀₂) was measured in the same manner as in Example 1.

The interlayer distance was 13.4 Å, and N-methylformamide was confirmed to be present between the layers in the two-dimensional particles included in the film of Example 3.

### Measurement of Conductivity and Change in Conductivity

Conductivity and a change in conductivity were measured in the same manner as in Example 1.

### Comparative Example 1

### Preparation of Two-Dimensional Particles

(1) Preparation of a precursor (MAX), (2) etching of the precursor, (3) cleaning, (4) intercalation, (5) delamination and cleaning, (6) drying, and (7) mixing with N-methylformamide were performed in the same manner as in Example 1 to obtain a slurry comprising two-dimensional particles.

### Preparation of Film

Using the slurry obtained by the above method, a spray film was prepared in the same manner as in Example 1. The spray film was dried at 100° C. for 2 hours using an atmospheric oven, and then further dried at 150° C. for 16 hours using a vacuum oven to prepare a film.

### Measurement of Content of N-methylformamide

The content (mol) of N-methylformamide with respect to 1 mol of MₘXₙ was measured in the same manner as in Example 2.

### Measurement of Conductivity and Change in Conductivity

Conductivity and a change in conductivity were measured in the same manner as in Example 1.

### Comparative Example 2

### Preparation of Two-Dimensional Particles

(1) Preparation of a precursor (MAX), (2) etching of the precursor, (3) cleaning, (4) intercalation, (5) delamination and cleaning, (6) drying, and (7) mixing with N-methylformamide were performed in the same manner as in Example 1 to obtain a slurry comprising two-dimensional particles.

### Preparation of Film

Using the slurry obtained by the above method, a filtration film was prepared in the same manner as in Example 3. The filtration film was dried at 200° C. for 16 hours using a vacuum oven to prepare a film.

### Measurement of Content of N-methylformamide

The content (mol) of N-methylformamide with respect to 1 mol of MₘXₙ was measured in the same manner as in Example 2.

### Measurement of Conductivity and Change in Conductivity

Conductivity and a change in conductivity were measured in the same manner as in Example 1.

### Comparative Example 3

### Preparation of Two-Dimensional Particles

Preparation of a precursor (MAX), (2) etching of the precursor, (3) cleaning, (4) intercalation, (5) delamination and cleaning, (6) drying, and (7) mixing with N-methylformamide were performed in the same manner as in Example 1 to obtain a slurry comprising two-dimensional particles.

### Preparation of Film

Using the slurry obtained by the above method, a filtration film was prepared in the same manner as in Example 3. The filtration film was dried at 100° C. for 2 hours using an atmospheric oven, and then further dried at 150° C. for 16 hours using a vacuum oven to prepare a film.

### Measurement of Content of N-methylformamide

The content (mol) of N-methylformamide with respect to 1 mol of MₘXₙ was measured in the same manner as in Example 2.

### Measurement of Conductivity and Change in Conductivity

Conductivity and a change in conductivity were measured in the same manner as in Example 1.

### Comparative Example 4

### Preparation of Two-Dimensional Particles

(1) Preparation of a precursor (MAX), (2) etching of the precursor, (3) cleaning, (4) intercalation, (5) delamination and cleaning, and (6) drying were performed in the same manner as in Example 1 to obtain a dried product.

### Preparation of Film

A predetermined amount of the dried product was taken in a 50 mL centrifuge tube, and pure water was added thereto. At this time, the amount of pure water added was adjusted so that the concentration of the delaminated product in the mixture was 1.5% by mass. Thereafter, the mixture was stirred on a shaker for 15 minutes to obtain a slurry.

Then, the slurry was placed in a 25 mL syringe, and the syringe was set on a spray coater. Then, a 3 cm square glass substrate (Tempax manufactured by SCHOTT) was cleaned with oxygen plasma and set on a stage with suction of a spray coater. The slurry was applied to the cleaned surface and dried with hot air 20 times to prepare a spray film.

Spray coating conditions
Atomization pressure: 0.5 MPa
Distance between nozzle tip and substrate: 15 cm
Liquid delivery amount: 5 mL/s
Sweep speed: 150 mm/s
Stage heater: 45° C.

The spray film was dried at 80° C. for 2 hours using an atmospheric oven, and then further dried at 150° C. for 16 hours using a vacuum oven to prepare a film.

### Measurement of Content of N-methylformamide

The content (mol) of N-methylformamide with respect to 1 mol of MₘXₙ was measured in the same manner as in Example 2.

Measurement of Interlayer Distance (d₀₀₂)

A correlation distance (d₀₀₂) was measured in the same manner as in Example 1. The interlayer distance was 10.9 Å.

### Measurement of Conductivity and Change in Conductivity

Conductivity and a change in conductivity were measured in the same manner as in Example 1.

### Comparative Example 5

### Preparation of Two-Dimensional Particles

Preparation of a precursor (MAX), (2) etching of the precursor, (3) cleaning, (4) intercalation, (5) delamination and cleaning, and (6) drying were performed in the same manner as in Example 1 to obtain a dried product.

### Preparation of Film

A predetermined amount of the dried product was taken in a 50 mL centrifuge tube, and pure water was added thereto. At this time, the amount of pure water added was adjusted so that the concentration of the delaminated product in the mixture was 1.5% by mass. Thereafter, the mixture was stirred on a shaker for 15 minutes to obtain a slurry.

The slurry was subjected to suction filtration to prepare a filtration film. As a filter for suction filtration, a membrane filter (Durapore manufactured by Merck Corporation, pore diameter: 0.45 m) was used. The filtration film was dried at 150° C. for 16 hours using a vacuum oven to prepare a film.

### Measurement of Content of N-methylformamide

The content (mol) of N-methylformamide with respect to 1 mol of MₘXₙ was measured in the same manner as in Example 2.

### Measurement of Conductivity and Change in Conductivity

Conductivity and a change in conductivity were measured in the same manner as in Example 1.

The content, conductivity, and conductivity retention ratio of N-methylformamide (NMF) with respect to 1 mol of MₘXₙ are shown in Table 1.

TABLE 1

| | NMF Content with | | |
|---|---|---|---|
| | respect to 1 mol of | | |
| | MₘXₙ | Conductivity | Change in |
| | (mol) | (S/cm) | Conductivity |
| Example 1 | 0.104 | 5,934 | 100% |
| Example 2 | 0.144 | 8,770 | 100% |
| Example 3 | 0.136 | 1,803 | 100% |
| Comparative | 0.087 | 7,500 | 74% |
| Example 1 | | | |
| Comparative | 0.101 | 2,080 | 60% |
| Example 2 | | | |
| Comparative | 0.067 | 2,964 | 63% |
| Example 3 | | | |
| Comparative | 0.079 | 1,776 | 31% |
| Example 4 | | | |
| Comparative | 0.068 | 3,407 | 73% |
| Example 5 | | | |

Table 1. The content, conductivity, and conductivity retention ratio of N-methylformamide (NMF) with respect to 1 mol of MₘXₙ.

Examples 1 to 3 were examples of the present disclosure, and a decrease in conductivity with time was suppressed, and particularly, a decrease in conductivity with time was suppressed even under high temperature and high humidity.

Comparative Examples 1 to 5 were examples in which the content of NMF with respect to 1 mol of MₘXₙ was less than 0.104 mol, and the conductivity was confirmed to decrease with time.

The present disclosure comprises the following:
[1]A film comprising two-dimensional particles,
   wherein the two-dimensional particles are two-dimensional particles having one or plural layers, and comprise N-methylformamide,
   the layer comprises: a layer body represented by a formula below:

MₘXₙ
wherein M is at least one metal of Group 3, 4, 5, 6, or 7,
   X is a carbon atom, a nitrogen atom, or a combination thereof,
   n is 1 to 4, and
   m is more than n and 5 or less; and
a modifier or terminal T existing on a surface of the layer body, wherein T is at least one selected from the group consisting of a hydroxyl group, a fluorine atom, a chlorine atom, an oxygen atom, and a hydrogen atom,
the N-methylformamide is disposed between two of the layers adjacent to each other, and
a content of the N-methylformamide in the film is 0.104 mol or more with respect to 1 mol of MₘXₙ.
[2] The film according to [1], wherein the layer body comprises Ti₃C₂.
[3]A method for producing a film comprising:
   (a) preparing a precursor represented by a formula below:

MₘAXₙ
wherein M is at least one metal of Group 3, 4, 5, 6, or 7 and comprises at least Ti,
   X is a carbon atom, a nitrogen atom, or a combination thereof,
   A is at least one element of Group 12, 13, 14, 15, or 16,
   n is 1 to 4, and
   m is more than n and 5 or less;
(b) removing at least a part of A atoms from the precursor using an etching solution to obtain an etched product;
(c) cleaning the etched product to obtain an etched cleaned product;
(d) mixing the etched cleaned product with an intercalator to obtain an intercalated product;
(e) stirring the intercalated product to obtain a delaminated product in which the intercalated product is delaminated;
(f) mixing the delaminated product with N-methylformamide to obtain a mixed solution;
(h) forming a precursor film using the mixed solution; and
(i) drying the precursor film under normal pressure to form the film.
[4] The method according to [3], wherein the precursor film is dried at a drying temperature of 190° C. or lower.
[5]A method for producing a film comprising:
   (a) preparing a precursor represented by a formula below:

MₘAXₙ
wherein M is at least one metal of Group 3, 4, 5, 6, or 7 and comprises at least Ti,
   X is a carbon atom, a nitrogen atom, or a combination thereof,
   A is at least one element of Group 12, 13, 14, 15, or 16,
   n is 1 to 4, and
   m is more than n and 5 or less;
(b) removing at least a part of A atoms from the precursor using an etching solution to obtain an etched product;
(c) cleaning the etched product to obtain an etched cleaned product;
(d) mixing the etched cleaned product with an intercalator to obtain an intercalated product;
(e) stirring the intercalated product to obtain a delaminated product in which the intercalated product is delaminated;
(g) drying the delaminated product to obtain a dried product; (fl) permeating N-methylformamide into the dried product of the delaminated product to form a precursor film; and
(i) drying the precursor film under normal pressure to form the film.

### REFERENCE SIGNS LIST

1a, 1b Layer body (MₘXₙ layer)
3a, 5a, 3b, 5b Modifier or terminal T
7a, 7b MXene layer
10, 10a, 10b MXene particles (two-dimensional particles of layered material)

1. A film comprising two-dimensional particles,
wherein the two-dimensional particles are two-dimensional particles having one or plural layers, and comprise N-methylformamide,
wherein the one or plural layers comprises a layer body represented by a formula:
MₘXₙ
wherein “M” is at least one Group 3, 4, 5, 6, or 7 metal,
“X” is a carbon atom, a nitrogen atom, or a combination thereof,
“n” is 1 to 4, and
“m”>“n” and “m”≤5; and
at least one modifier or terminal “T” is present on a surface of the layer body, wherein each “T” is a hydroxyl group, a fluorine atom, a chlorine atom, an oxygen atom, or a hydrogen atom,
the N-methylformamide is disposed between two adjacent layers of the one or plural layers, and
a content of the N-methylformamide in the film is 0.104 mol or more with respect to 1 mol of MₘXₙ.

2. The film according to claim 1, wherein the layer body comprises Ti₃C₂.

3. A method for producing a film, the method comprising:
(a) preparing a precursor represented by a formula:
MₘAXₙ
wherein “M is at least one metal of Group 3, 4, 5, 6, or 7 and comprises at least Ti,
“X” is a carbon atom, a nitrogen atom, or a combination thereof,
“A” is at least one Group 12, 13, 14, 15, or 16 element atom,
“n” is 1 to 4, and
“m”>“n” and “m”≤5;
(b) removing at least a portion of the “A” element atoms from the precursor using an etching solution to obtain an etched product;
(c) cleaning the etched product to obtain an etched and cleaned product;
(d) mixing the etched and cleaned product with an intercalator to obtain an intercalated product;
(e) stirring the intercalated product to obtain a delaminated product in which the intercalated product is delaminated;
(f) mixing the delaminated product with N-methylformamide to obtain a mixed solution;
(h) forming a precursor film using the mixed solution; and
(i) drying the precursor film under normal pressure to form the film.

4. The method according to claim 3, wherein the precursor film is dried at a drying temperature of 190° C. or lower.

5. The film according to claim 1, wherein “M” comprises at least Ti.

6. The film according to claim 1, wherein “M” comprises at least one selected from the group consisting of Ti, Zr, Hf, V, Nb, Ta, Cr, Mo, and Mn.

7. The film according to claim 1, wherein the one or plural layers have a thickness of 0.8 nm to 3 nm.

8. The film according to claim 1, wherein the two-dimensional particles have an average thickness of 1 nm to 15 nm.

9. A method for producing a film, the method comprising:
(a) preparing a precursor represented by a formula below:
MₘAXₙ
wherein M is at least one metal of Group 3, 4, 5, 6, or 7 and comprises at least Ti,
X is a carbon atom, a nitrogen atom, or a combination thereof,
A is at least one element of Group 12, 13, 14, 15, or 16,
n is 1 to 4, and
m is more than n and 5 or less;
(b) removing at least a part of A atoms from the precursor using an etching solution to obtain an etched product;
(c) cleaning the etched product to obtain an etched cleaned product;
(d) mixing the etched cleaned product with an intercalator to obtain an intercalated product;
(e) stirring the intercalated product to obtain a delaminated product in which the intercalated product is delaminated;
(g) drying the delaminated product to obtain a dried product;
(f) permeating N-methylformamide into the dried product of the delaminated product to form a precursor film; and
(i) drying the precursor film under normal pressure to form the film.

10. The method of claim 9, wherein normal pressure comprises 900 hPa to 1,200 hPa as an absolute pressure.

11. The method of claim 9, wherein the drying step (i) comprises drying the precursor film at a temperature between 80° C. and 190° C.

12. The method of claim 9, wherein the drying step (i) is completed within 1 to 5 hours.

13. An electrode comprising the film according to claim 1.

14. The electrode of claim 13, wherein the film is at least partially covered with a substrate and/or a protective layer.

15. The electrode of claim 13, wherein the film is at least partially exposed.
